(19) United States
(12) Patent Application Publication
(10) Pub. No.: US 2012/0085961 A1
(43) Pub. Date: Apr. 12, 2012

(54) METHOD FOR IMPROVING SOUND DAMPING PERFORMANCE FOR AUTOMOTIVE INTERIOR APPLICATIONS

(75) Inventors: Marina Rogunova, Pittsburgh, PA (US); Bruce D. Lawrey, Pittsburgh, PA (US); Charles David Siler, Rochester Hills, MI (US); Jose Chirino, McMurray, PA (US)

(73) Assignee: Bayer MaterialScience LLC, Pittsburgh, PA (US)

(21) Appl. No.: 12/902,372

(22) Filed: Oct. 12, 2010

(51) Int. Cl. C08L 75/04

(52) U.S. Cl. 252/62

(57) ABSTRACT

The present invention provides a method for improving damping performance and viscoelastic response in a vehicle interior part, the method involving including a thermoplastic blend in the part, wherein the thermoplastic blend contains 50 to 70 percent by weight of a thermoplastic aromatic polycarbonate and 5 to 10 percent by weight of a thermoplastic polyester-polyol-based polyurethane, wherein the percents are based on the combined weights of the thermoplastic aromatic polycarbonate and thermoplastic polyurethane. The inventive methods may find particular application in vehicles such as vehicles such as automobiles, trucks, buses, trains, airplanes, etc.

### FIELD OF THE INVENTION

The present invention relates in general to, sound management and more specifically to a method to provide an economical and effective way of sound management, e.g. to improve both sound blocking and vibration damping in vehicles such as automobiles, trucks, buses, trains, airplanes, etc.

### BACKGROUND OF THE INVENTION

In modern vehicles, the transfer of vibrations generated by a dynamic force generator, such as an engine, a motor, a pump or a gearbox, via structural elements to an emitting surface such as an instrumental panel, seats and doors, leads to the emission of structure borne noise.

Automotive customers often complain about static noise such as squeak and rattle in a car's interior. Squeaking is believed to originate from the so-called “stick-slip” effect, i.e., a periodic change of two parts moving against each other or being stuck. The stick-slip effect is correlated to unfavorable static and dynamic friction behavior of two parts being in contact causing a stimulation of vibration.

A number of different solutions have been suggested to at least reduce such structure borne noise. The traditional “band aid” or “find-and-fix” approach has been applied at the late design stage, which can be both expensive and time consuming.

Much effort has been expended to find squeak-free elastomeric materials. Because of the tremendous number of potential sources involved in the generation of the squeak, as well as highly demanding specification requirements for automotive and other transportation vehicle interior structural parts, no single material provides the ultimate fix-all solution. Numerous manufacturers have tried several “slip-coatings” and surface finish textures on elastomeric materials but have met with limited success due to problems with wear and atmospheric durability. Research in this field has gravitated towards finding effective material friction pairs that minimize squeaks.

A number of blended materials of polycarbonate and thermoplastic polyurethane are available. For example, Skochdopole, at al., in U.S. Pat. No. 4,912,177, disclose a binary thermoplastic polyblend consisting essentially of a thermoplastic aromatic polycarbonate and a thermoplastic polyester polyol-based polyurethane. The polyblends of the '177 patent are said to exhibit improved hydrocarbon solvent resistance and melt flow properties over polycarbonate resins.

U.S. Pat. No. 5,162,461, issued to Skochdopole, et al. provides a binary thermoplastic polyblend made of a thermoplastic aromatic polycarbonate and a polycaprolactone polyol-based thermoplastic polyurethane. The polyblends of the '461 patent are said to exhibit improved hydrocarbon solvent resistance and melt flow properties.

Henton, et al., in U.S. Pat. No. 5,219,933, describe a thermoplastic blend based on polycarbonate, thermoplastic polyurethane and an impact modifier. These resins are said to be suitable for preparing molded or shaped articles having excellent combinations of processability, heat resistance, flexibility, solvent resistance and low temperature toughness. These resins contain (a) about 35 to about 65 percent by weight of a thermoplastic aromatic polycarbonate; (b) about 35 to about 65 percent by weight of a thermoplastic polyurethane; and (c) about 1 to about 20 percent by weight of an impact modifier, which weight percentages are based on the combined weights of the polycarbonate and thermoplastic polyurethane. A preferred embodiment of the invention of Henton, et al. is a thermoplastic automobile part, such as a bumper facia, prepared from such a thermoplastic resin.

U.S. Pat. Nos. 5,308,894 and 5,369,154, both issued to Laughner at al., disclose a polycarbonate blend that is said to have good impact and flexural strength, good weldline properties, and good solvent resistance which is prepared by admixing with polycarbonate an aromatic polyester, an olefinic epoxide-containing modifier, and a thermoplastic elastomer. Optionally, a graft copolymer of the core-shell type and a rubber-modified styrene/acrylonitrile copolymer may be used as additional impact modifiers.

A need continues to exist in the art for methods of improving damping performance and viscoelastic response in vehicle interiors such as automobiles, trucks, buses, trains and airplanes without sacrificing such key performance attributes as high flow and low temperature ductility.

### SUMMARY OF THE INVENTION

Accordingly, the method of the present invention utilizes a thermoplastic blend composition made of a thermoplastic aromatic polycarbonate (“PC”) and a thermoplastic polyester-polyol-based polyurethane (“TPU”). The polycarbonate/thermoplastic polyurethane blends exhibit improved damping performance and viscoelastic response without sacrificing such key performance attributes as high flow and low temperature ductility. The inventive methods may find particular application in vehicle interiors such as automobiles, trucks, buses, trains, airplanes, etc.

These and other advantages and benefits of the present invention will be apparent from the Detailed Description of the Invention herein below.

### BRIEF DESCRIPTION OF THE FIGURES

The present invention will now be described for purposes of illustration and not limitation in conjunction with the figures, wherein:

FIG. 1 shows a Dynamic Mechanical thermal Analysis frequency sweep at 23° C.;

FIG. 2 illustrates a Dynamic Mechanical thermal Analysis frequency sweep, at 0° C.; and

FIG. 3 depicts a Dynamic Mechanical thermal Analysis frequency sweep, at −30° C.

### DETAILED DESCRIPTION OF THE INVENTION

The present invention will now be described for purposes of illustration and not limitation. Except in the operating examples, or where otherwise indicated, all numbers expressing quantities, percentages, OH numbers, functionalities and so forth in the specification are to be understood as being modified in all instances by the term “about.” Equivalent weights and molecular weights given herein in Daltons (Da) are number average equivalent weights and number average molecular weights respectively, unless indicated otherwise.

The present invention provides a method for improving damping performance and viscoelastic response in a vehicle interior part, the method involving including a thermoplastic blend in the part, wherein the thermoplastic blend contains about 50 to about 70 percent by weight of a thermoplastic aromatic polycarbonate and about 5 to about 10 percent by weight of a thermoplastic polyurethane, wherein the percents are based on the combined weights of the thermoplastic aromatic polycarbonate and thermoplastic polyurethane.

The present invention also provides a method for improving damping performance and viscoelastic response in a vehicle interior part, the method involving including a thermoplastic blend in the part, wherein the thermoplastic blend contains 50 to 70 percent by weight of a thermoplastic aromatic polycarbonate and 5 to 10 percent by weight of a thermoplastic polyester-polyol-based polyurethane, wherein the percents are based on the combined weights of the thermoplastic aromatic polycarbonate and thermoplastic polyurethane.

Suitable polycarbonate resins for preparing ee composition useful in the methods of the present invention are homopolycarbonates and copolycarbonates, both linear or branched resins and mixtures thereof.

The polycarbonates have a weight average molecular weight of preferably 10,000 to 200,000, more preferably 20,000 to 80,000 and their melt flow rate, per ASTM D-1238 at 300° C., is preferably 1 to 65 g/10 min., more preferably 2 to 35 g/10 min. They may be prepared, for example, by the known diphasic interface process from a carbonic acid derivative such as phosgene and dihydroxy compounds by polycondensation (See, German Offenlegungsschriften 2,063,050; 2,063,052; 1,570,703; 2,211,956; 2,211,957 and 2,248,817; French Patent 1,561,518; and the monograph by H. Schnell, “Chemistry and Physics of Polycarbonates”, Interscience Publishers, New York, N.Y., 1964).

In the present context, dihydroxy compounds suitable for the preparation of the polycarbonates of the invention conform to the structural formulae (1) or (2) below.

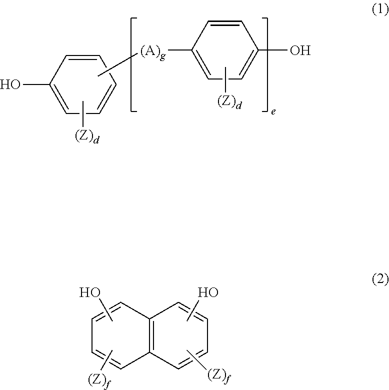

wherein
A denotes an alkylene group with 1 to 8 carbon atoms, an alkylidene group with 2 to 8 carbon atoms, a cycloalkylene group with 5 to 15

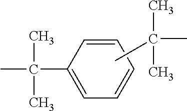

carbon atoms, a cycloalkylidene group with 5 to 15 carbon atoms, a carbonyl group, an oxygen atom, a sulfur atom, —SO— or —SO₂ or a radical conforming to
e and g both denote the number 0 to 1;
Z denotes F, Cl, Br or C₁-C₄-alkyl and if several Z radicals are substituents in one aryl radical, they may be identical or different from one another;
d denotes an integer of from 0 to 4; and
f denotes an integer of from 0 to 3.

Among the dihydroxy compounds useful in the practice of the invention are hydroquinone, resorcinol, bis-(hydroxyphenyl)-alkanes, bis-(hydroxy-phenyl)-ethers, bis-(hydroxyphenyl)-ketones, bis-(hydroxy-phenyl)-sulfoxides, bis-(hydroxyphenyl)-sulfides, bis-(hydroxyphenyl)-sulfones, and α,α-bis-(hydroxyphenyl)-diisopropylbenzenes, as well as their nuclear-alkylated compounds. These and further suitable aromatic dihydroxy compounds are described, for example, in U.S. Pat. Nos. 5,401,826, 5,105,004; 5,126,428; 5,109,076; 5,104,723; 5,086,157; 3,028,356; 2,999,835; 3,148,172; 2,991,273; 3,271,367; and 2,999,846, the contents of which are incorporated herein by reference.

Further examples of suitable bisphenols are 2,2-bis-(4-hydroxyphenyl)-propane (bisphenol A), 2,4-bis-(4-hydroxyphenyl)-2-methyl-butane, 1,1-bis-(4-hydroxyphenyl)-cyclohexane, α,α′-bis-(4-hydroxy-phenyl)-p-diisopropylbenzene, 2,2-bis-(3-methyl-4-hydroxyphenyl)-propane, 2,2-bis-(3-chloro-4-hydroxyphenyl)-propane, 4,4′-dihydroxy-diphenyl, bis-(3,5-dimethyl-4-hydroxyphenyl)-methane, 2,2-bis-(3,5-dimethyl-4-hydroxyphenyl)-propane, bis-(3,5-dimethyl-4-hydroxyphenyl)-sulfide, bis-(3,5-dimethyl-4-hydroxy-phenyl)-sulfoxide, bis-(3,5-dimethyl-4-hydroxyphenyl)-sulfone, dihydroxy-benzophenone, 2,4-bis-(3,5-dimethyl-4-hydroxyphenyl)-cyclohexane, α,α′-bis-(3,5-dimethyl-4-hydroxyphenyl)-p-diisopropyl-benzene and 4,4′-sulfonyl diphenol.

Examples of particularly preferred aromatic bisphenols are 2,2-bis-(4-hydroxyphenyl)-propane, 2,2-bis-(3,5-dimethyl-4-hydroxyphenyl)-propane, 1,1-bis-(4-hydroxyphenyl)-cyclohexane and 1,1-bis-(4-hydroxy-phenyl)-3,3,5-trimethylcyclohexane. The most preferred bisphenol is 2,2-bis-(4-hydroxyphenyl)-propane (bisphenol A).

The polycarbonate useful in the methods of the invention may entail in their structure units derived from one or more of the suitable bisphenols.

Among the resins suitable in the practice of the invention are phenolphthalein-based polycarbonate, copolycarbonates and terpolycarbonates such as are described in U.S. Pat. Nos. 3,036,036 and 4,210,741, both of which are incorporated by reference herein.

The polycarbonates useful in the invention may also be branched by condensing therein small quantities, e.g., 0.05 to 2.0 mol % (relative to the bisphenols) of polyhydroxyl compounds. Polycarbonates of this type have been described, for example, in German Offenlegungsschriften 1,570,533; 2,116,974 and 2,113,374; British Patents 885,442 and 1,079,821 and U.S. Pat. No. 3,544,514, which is incorporated herein by reference. The following are some examples of polyhydroxyl compounds which may be used for this purpose: phloroglucinol; 4,6-dimethyl-2,4,6-tri-(4-hydroxy-phenyl)-heptane; 1,3,5-tri-(4-hydroxyphenyl)-benzene; 1,1,1-tri-(4-hydroxyphenyl)-ethane; tri-(4-hydroxyphenyl)-phenyl-methane; 2,2-bis-[4,4-(4,4′-dihydroxydiphenyl)]-cyclohexyl-propane; 2,4-bis-(4-hydroxy-1-isopropylidine)-phenol; 2,6-bis-(2′-dihydroxy-5′-methylbenzyl)-4-methyl-phenol; 2,4-dihydroxybenzoic acid; 2-(4-hydroxy-phenyl)-2-(2,4-dihydroxy-phenyl)-propane and 1,4-bis-(4,4′-dihydroxytri-phenylmethyl)-benzene. Some of the other polyfunctional compounds are 2,4-dihydroxy-benzoic acid, trimesic acid, cyanuric chloride and 3,3-bis-(4-hydroxyphenyl)-2-oxo-2,3-dihydroindole.

In addition to the polycondensation process mentioned above, other processes for the preparation of the polycarbonates useful in the methods of the invention are polycondensation in a homogeneous phase and transesterification. The suitable processes are disclosed in U.S. Pat. Nos. 3,028,365; 2,999,846; 3,153,008; and 2,991,273 which are incorporated herein by reference.

The preferred process for the preparation of polycarbonates is the interfacial polycondensation process. Other methods of synthesis in forming the polycarbonates of the invention, such as disclosed in U.S. Pat. No. 3,912,688, incorporated herein by reference, may be used. Suitable polycarbonate resins are available in commerce, for instance, from Bayer MaterialScience under the MAKROLON trademark. The polycarbonate is present in the thermoplastic blend in the method of the invention from preferably 50 to 70 percent by weight of the combined weights of the thermoplastic aromatic polycarbonate and thermoplastic polyurethane present.

The inventive methods allow the use of both aromatic thermoplastic polyurethanes and aliphatic thermoplastic polyurethanes such as those prepared according to U.S. Pat. No. 6,518,389, the entire contents of which are incorporated herein by reference.

Thermoplastic polyurethane elastomers are well known to those skilled in the art. They are of commercial importance due to their combination of high-grade mechanical properties with the known advantages of cost-effective thermoplastic processability. A wide range of variation in their mechanical properties can be achieved by the use of different chemical synthesis components. A review of thermoplastic polyurethanes, their properties and applications is given in Kunststoffe [Plastics] 68 (1978), pages 819 to 825, and in Kautschuk, Gummi Kunststoffe [Natural and Vulcanized Rubber and Plastics] 35 (1982), pages 568 to 584.

Thermoplastic polyurethanes are synthesized from linear polyols, mainly polyester diols or polyether diols, organic diisocyanates and short chain diols (chain extenders). Catalysts may be added to the reaction to speed up the reaction of the components.

The relative amounts of the components may be varied over a wide range of molar ratios in order to adjust the properties. Molar ratios of polyols to chain extenders from 1:1 to 1:12 have been reported. These result in products with hardness values ranging from 80 Shore A to 75 Shore D.

Thermoplastic polyurethanes can be, produced either in stages (prepolymer method) or by the simultaneous reaction of all the components in one step (one shot). In the former, a prepolymer formed from the polyol and diisocyanate is first formed and then reacted with the chain extender. Thermoplastic polyurethanes may be produced continuously or batch-wise. The best-known industrial production processes are the so-called belt process and the extruder process.

Examples of the suitable polyols include difunctional polyether polyols, polyester polyols, and polycarbonate polyols. Small amounts, of trifunctional polyols may be used, yet care must be taken to make certain that the thermoplasticity of the thermoplastic polyurethane remains substantially un-effected.

Suitable polyester polyols include those prepared by polymerizing ε-caprolactone using an initiator such as ethylene glycol, ethanolamine and the like. Further suitable examples are those prepared by esterification of polycarboxylic acids. The polycarboxylic acids may be aliphatic, cycloaliphatic, aromatic and/or heterocyclic and they may be substituted, e.g., by halogen atoms, and/or unsaturated. The following are mentioned as examples: succinic acid; adipic acid; suberic acid; azelaic acid; sebacic acid; phthalic acid; isophthalic acid; trimellitic acid; phthalic acid anhydride; tetrahydrophthalic acid anhydride; hexahydrophthalic acid anhydride; tetrachlorophthalic acid anhydride, endomethylene tetrahydrophthalic acid anhydride; glutaric acid anhydride; maleic acid; maleic acid anhydride; fumaric acid; dimeric and trimeric fatty acids such as oleic acid, which may be mixed with monomeric fatty acids; dimethyl terephthalates and bis-glycol terephthalate. Suitable polyhydric alcohols include, e.g., ethylene glycol; propylene glycol-(1,2) and -(1,3); butylene glycol-(1,4) and -(1,3); hexanediol-(1,6); octanediol-(1,8); neopentyl glycol; (1,4-bis-hydroxy-methylcyclohexane); 2-methyl-1,3-propanediol; 2,2,4-tri-methyl-1,3-pentanediol; triethylene glycol; tetraethylene glycol; polyethylene glycol; dipropylene glycol; polypropylene glycol; dibutylene glycol and polybutylene glycol, glycerine and trimethylolpropane.

Suitable polyisocyanates for producing the thermoplastic polyurethanes useful in the present invention may be, for example, organic aliphatic diisocyanates including, for example, 1,4-tetramethylene diisocyanate, 1,6-hexamethylene diisocyanate, 2,2,4-trimethyl-1,6-hexamethylene diisocyanate, 1,12-dodecamethylene diisocyanate, cyclohexane-1,3- and -1,4-diisocyanate, 1-isocyanato-2-isocyanatomethyl cyclopentane, 1-isocyanato-3-isocyanatomethyl-3,5,5-trimethyl-cyclohexane (isophorone diisocyanate or IPDI), bis-(4-isocyanatocyclohexyl)-methane, 2,4′-dicyclohexylmethane diisocyanate, 1,3- and 1,4-bis-(isocyanatomethyl)-cyclohexane, bis-(4-isocyanato-3-methylcyclohexyl)-methane, α,α,α′,α′-tetramethyl-1,3- and/or -1,4-xylylene diisocyanate, 1-isocyanato-1-methyl-4(3)-isocyanatomethyl cyclohexane, 2,4- and/or 2,6-hexahydrotoluylene diisocyanate, and mixtures thereof. Also suitable is naphthalene 1,5 di-isocyanate (1,5 NDI).

Preferred chain extenders with molecular weights of 62 to 500 include aliphatic dials containing 2 to 14 carbon atoms, such as ethanediol, 1,6-hexanediol, diethylene glycol, dipropylene glycol, and 1,4-butanediol in particular, for example. However diesters of terephthalic acid with glycols containing 2 to 4 carbon atoms are also suitable, such as terephthalic acid-bis-ethylene glycol or -1,4-butanediol for example, or hydroxyalkyl ethers of hydroquinone, such as 1,4-di-(β-hydroxyethyl)-hydroquinone for example, or (cyclo)aliphatic diamines, such as isophorone diamine, 1,2- and 1,3-propylenediamine, N-methyl-propylenediamine-1,3 or N,N′-dimethyl-ethylenediamine, for example, and aromatic diamines, such as toluene 2,4- and 2,6-diamines, 3,5-diethyltoluene 2,4- and/or 2,6-diamine, and primary ortho-, di-, tri- and/or tetraalkyl-substituted 4,4′-diaminadiphenylmethanes, for example. Mixtures of the aforementioned chain extenders may also be used. Optionally, triol chain extenders having a molecular weight of 62 to 500 may also be used. Moreover, customary monofunctional compounds may also be used in small amounts, e.g., as chain terminators or demolding agents. Alcohols such as octanol and stearyl alcohol or amines such as butylamine and stearylamine may be cited as examples.

To prepare the polyurethanes, the synthesis components may be reacted, optionally in the presence of catalysts, auxiliary agents and/or additives, in amounts such that the equivalent ratio of NCO groups to the sum of the groups which react with NCO, particularly the OH groups of the low molecular weight diols/triols and polyols, is 0.9:1.0 to 1.2:1.0, preferably 0.95:1.0 to 1.10:1.0.

Suitable catalysts include tertiary amines which are known in the art, such as triethylamine, dimethyl-cyclohexylamine, N-methylmorpholine, N,N′-dimethyl-piperazine, 2-(dimethyl-aminoethoxy)-ethanol, diazabicyclo-(2,2,2)-octane and the like, for example, as well as organic metal compounds in particular, such as titanic acid esters, iron compounds, tin compounds, e.g., tin diacetate, tin dioctoate, tin dilaurate or the dialkyltin salts of aliphatic carboxylic acids such as dibutyltin diacetate, dibutyltin dilaurate or the like. The preferred catalysts are organic metal compounds, particularly titanic acid esters and iron and/or tin compounds.

In addition to difunctional chain extenders, small quantities of up to about 5 mol. %, based on moles of the bifunctional chain extender used, of trifunctional or more than trifunctional chain extenders may also be used.

Trifunctional or more than trifunctional chain extenders of the type in question are, for example, glycerol, trimethylolpropane hexanetriol, pentaerythritol and triethanolamine.

Suitable thermoplastic polyurethanes are available in commerce, for instance, from Bayer MaterialScience under the TEXIN, and DESMOPAN names and from Dainippon in & Chemicals under the PANDEX name. The thermoplastic polyurethane is present in the thermoplastic blend useful in the inventive methods in from preferably 5-10 percent by weight of the combined weights of the thermoplastic aromatic polycarbonate and thermoplastic polyurethane present.

The production of the compositions useful in the inventive methods may be carried out in standard mixing units, particularly extruders and kneaders. All components may be mixed all at once or, as required, stepwise.

This compounding may be combined with the incorporation of reinforcing materials and/or pigments suitable for polycarbonates, polyurethanes and/or graft polymers, although such additives may also be separately incorporated in the molding compounds and/or components, individual examples of such additives include inter alia glass fibers, carbon fibers, fibers of organic and inorganic polymers, calcium carbonate, talcum, silica gel, quartz powder, flow aids, mold release agents, stabilizers, carbon black and TiO₂.

### EXAMPLES

The present invention is further illustrated, but is not to be limited, by the following examples. All quantities given in “parts” and “percents” are understood to be by weight, unless otherwise indicated. The following components were used in preparing the compositions used in the Examples. The amounts of each are given below in Table I.

| | |
|---|---|
| PC A | a bisphenol-A based, linear homopolycarbonate |
| | having melt flow rate of about 22-25 g/10 min (at |
| | 300° C., 1.2 kg) per ASTM D 1238, commercially |
| | available as MAKROLON PCFS2408P from Bayer |
| | MaterialScience; |
| PC B | a bisphenol-A based, linear homopolycarbonate |
| | having melt flow rate of about 10-14 g/10 min (at |
| | 300° C., 1.2 kg) per ASTM D 1238 commercially |
| | available as MAKROLON 2608 from Bayer |
| | MaterialScience; |
| PC-C | a bisphenol-A based, linear homopolycarbonate |
| | having melt flow rate of about 4-5.6 g/10 min (at |
| | 300° C., 1.2 kg) per ASTM D 1238, commercially |
| | available as MAKROLON 3208 from Bayer |
| | MaterialScience; |
| ABS polymer A | acrylonitrile/butadiene/styrene terpolymer, |
| | commercially available as TERLURAN HI-10 from |
| | BASF; |
| ABS polymer B | acrylonitrile/butadiene/styrene Terpolymer |
| | commercially available as SANTAC AT-08 from |
| | Nippon A&L Inc.; |
| ABBS Copolymer | polymer blend of acrylonitrile/butyl acrylate/styrene |
| | and styrene/acrylonitrile, commercially available from |
| | UMG ABS Ltd, (Tokyo, Japan); |
| TPU | an aromatic polyester-polyol-based thermoplastic |
| | polyurethane, commercially available as TEXIN 288 |
| | from Bayer MaterialScience; |
| SAN | styrene-acrylonitrile commercially available as |
| | LUSTRAN SAN DN50 from Ineos; |
| Antioxidant A | IRGANOX 1076, a product of Ciba Specialties; |
| Antioxidant B | Tetrakis[methylene 3-(3,5-di-t-butyl-4- |
| | hydroxyphenyl)-propionate]methane, commercially |
| | available as IRGANOX 1010 from Ciba-Geigy; |
| Graft polymer | SAN grated EPDM having rubber content of 60% |
| | relative to its weight, commercially available from |
| | UMG ABS Ltd, (Tokyo, Japan); |
| Impact modifer | a linear terpolymer which contains from 50 to 85% of |
| | ethylene units, from 5 to 40% of ester derived from |
| | (meth)acrylic acid, and from 2 to 10% of Glycidyl |
| | ester (glycidyl acrylate, glycidyl methacrylatea)or |
| | glycidyl ethers (allyl glycidyl ether) with epoxy |
| | functional group, commercially available as Lotader |
| | AX 8900/GMA/MA Ethylene Terpolymer, |
| | commercially available from Arkema; |
| Polysiloxane | Poly(dimethyl)siloxane containing pendant |
| | glycidylether groups along the siloxane repeat units |
| | made according to U.S. Pat No. 5,405,892; |
| Release agent | a pentaerythritol tetrastearate, commercially available |
| | as GLYCOLUBE P from Lonza Chemical Company; |
| Thermal stabilizer | aromatic ester of phosphoric acid; |
| UV Stabilizer | 2-(2′-hydroxy-5′-t-octylphenyl)benzotriazole, |
| | commercially available as TINUVIN 329 from BASF. |

The present inventors have modified polycarbonate/ABS blends for use in the inventive methods to have better sound damping properties in the application temperature range of −20° C. to 60° C. The inventive methods may find particular application in vehicle interiors such as automobiles, trucks, buses, trains, airplanes, etc.

### Examples 1-9

Dynamic Mechanical Analysis has been used to evaluate and study the viscoelastic behavior and damping performance of the new polycarbonate blends. Dynamic Mechanical Analysis (DMA) provides a useful tool to study the dynamic properties of a material and is often used to characterize the sound or vibration damping performance of polymers, particularly viscoelastic polymers. DMA measures the modulus (stiffness) and damping (energy dissipation) properties of materials as they are deformed under dynamic stress. With DMA, a sinusoidal force or stress is applied to a sample and the resulting sinusoidal deformation or strain is monitored. The ratio of the dynamic stress to the dynamic strain yields the complex modulus, E*, which can be further broken down to yield the storage modulus, E′, and the loss modulus, E″. The storage modulus (E′) refers to the ability of a material to store energy and it is related to the stiffness of the material. The loss modulus (E″) represents the dissipative characteristics of the sample as a result of the material's given molecular motions and this reflects the damping characteristics of the polymer. High values of the loss modulus over a wide range of frequency is generally regarded as the platform for good broadband damping properties.

Results are presented below in Table II. Notched Izod was determined according to ASTM D 256; High Speed Puncture according to ASTM D 3763; Specular Gloss according to ASTM D 523; Deflection Temperature according to ASTM D 648; and VICAT softening temperature according to ASTM D 1525. The inventors have determined the most suitable thermoplastic polyurethane (TPU) for the inventive methods is TEXIN 288, an aromatic polyester-polyol-based thermoplastic polyurethane. Incorporation of TEXIN 288 material into the different polycarbonate blends improved a storage modulus and thus allowed considerably improved damping performance of the final product in the inventive methods.

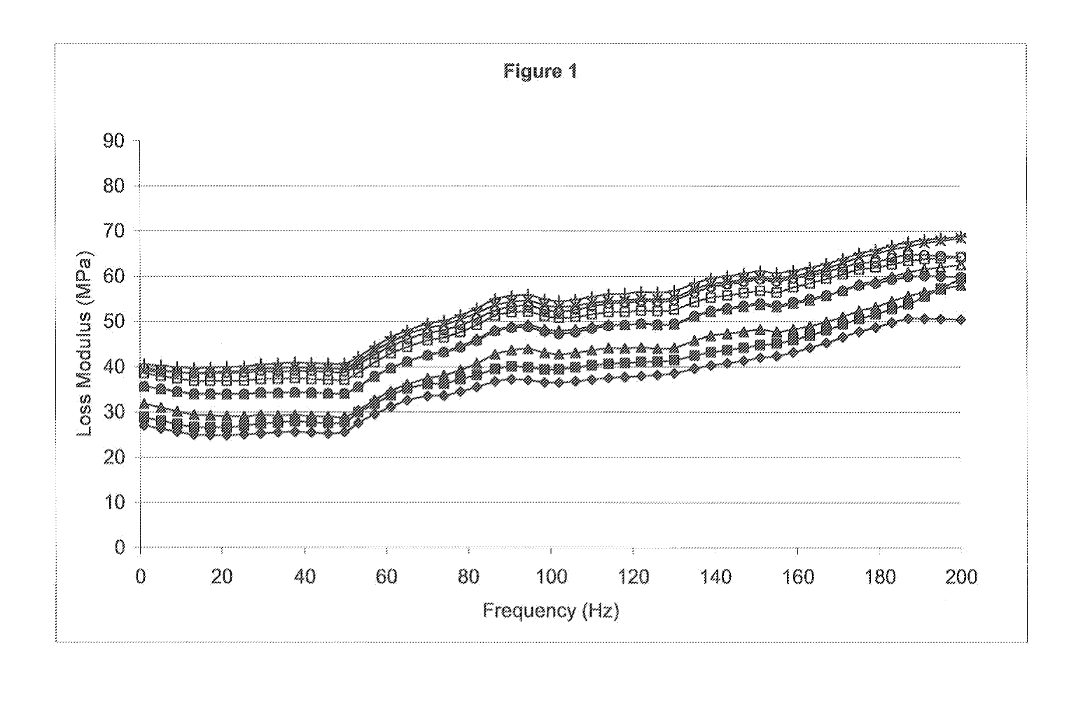

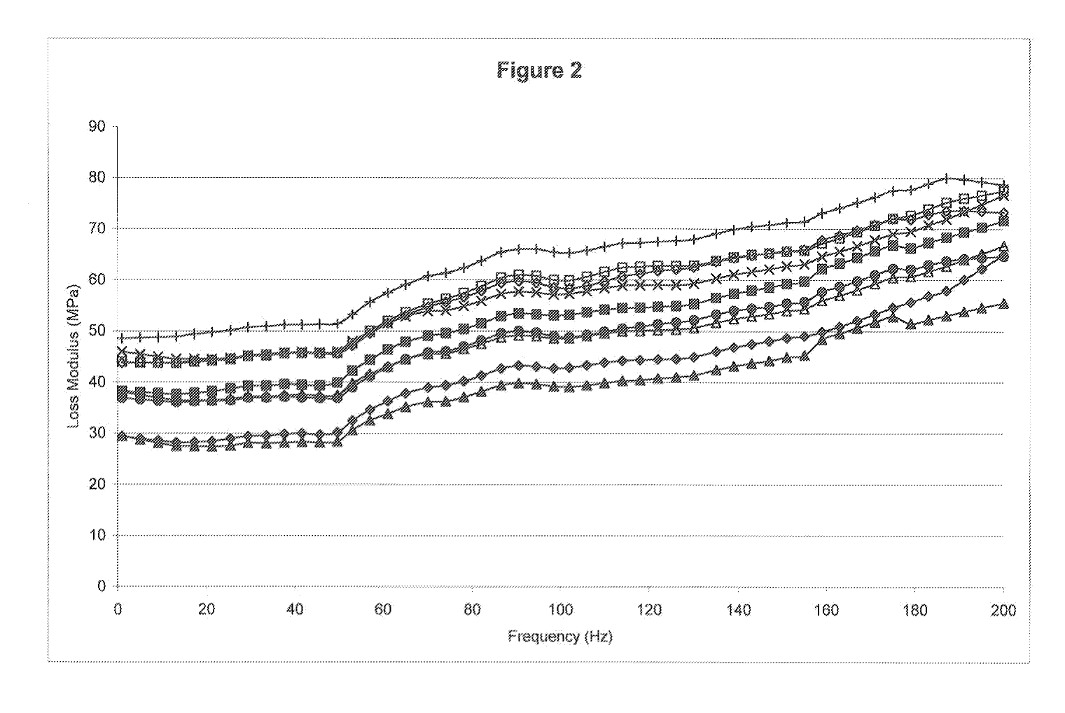

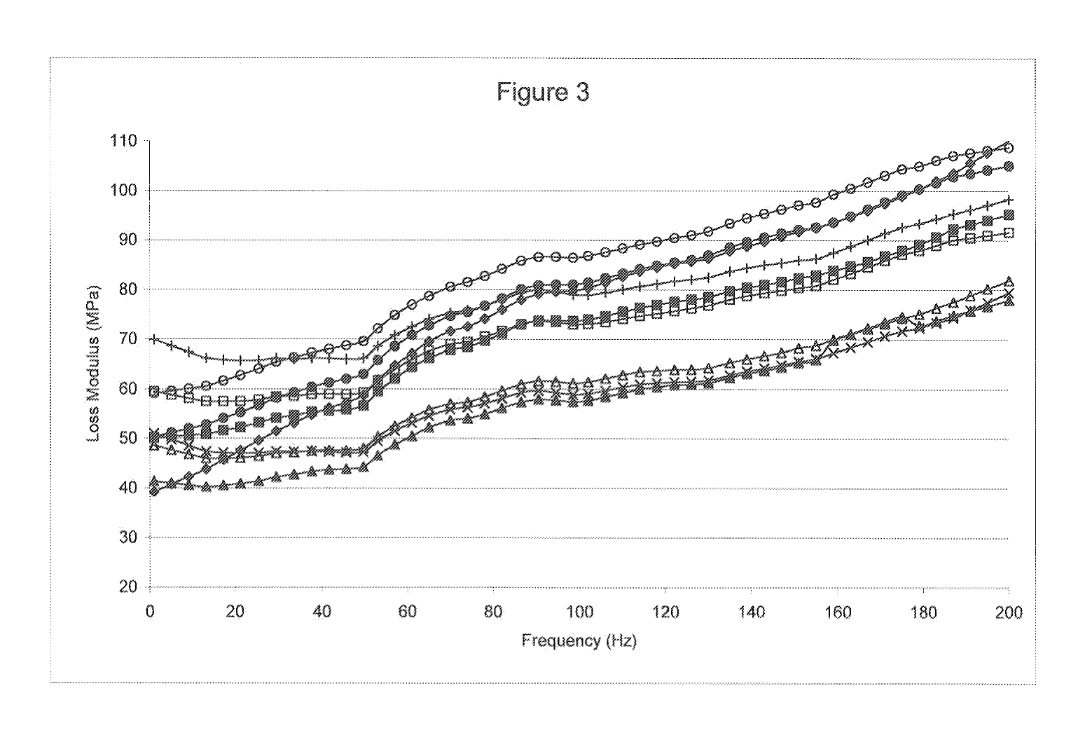

The damping performance of the formulations based on polycarbonate/thermoplastic polyurethane blends was evaluated at the three different temperatures (23 C, 0 C and −30 C). In the Figures showing Dynamic Mechanical thermal Analysis. frequency sweep at 23° C. (FIG. 1); 0° C. (FIG. 2); and −30° C. (FIG. 3), data points from Example 1 are represented by solid triangles (▴); Example 2 by solid squares (▪); Example 3 by solid diamonds (♦); Example 4 by open triangles (Δ); Example 5 by crosses (X); Example 6 by open squares (□); Example 7 by plus signs (+); Example 8 by solid circles (); and Example 9 by open circles (◯).

As will be apparent by reference to Table II and FIGS. 1-3, improved damping performance in accordance with present invention has been demonstrated in the tested temperature range for the polycarbonate/thermoplastic polyurethane formulations, in addition to the improved damping performance, as is apparent by reference to Table II, a desired combination of LTD (low temperature ductility), excellent flow properties, and low surface gloss was achieved.

Table III presents tensile and flexural properties of the materials used in the inventive process which were determined at 23° C. Tensile strength at yield; tensile strength at break; ultimate tensile strength; elongation at yield; elongation at break; and tensile modulus were all determined according to ASTM D 638. Width; thickness; flexural stress at 5% deflection; strain at maximum stress; maximum flexural stress and flexural modulus were all determined according to ASTM D 790.

TABLE I

| Component | Ex. 1 | Ex. 2 | Ex. 3 | Ex. 4 | Ex. 5 | Ex. 6 | Ex. 7 | Ex. 8 | Ex. 9 |
|---|---|---|---|---|---|---|---|---|---|
| PC A | 68.75 | 0 | 58.85 | 63.75 | 58.75 | 0 | 0 | 58.85 | 53.85 |
| PC B | 0 | 47.21 | 0 | 0 | 0 | 47.21 | 47.21 | 0 | 0 |
| PC-C | 0 | 9.49 | 6.6 | 0 | 0 | 9.49 | 9.49 | 6.6 | 6.6 |
| Release agent | 0.75 | 0.5 | 0.5 | 0.75 | 0.75 | 0.5 | 0.5 | 0.5 | 0.5 |
| ABS polymer A | 23.7 | 0 | 0 | 23.7 | 23.7 | 0 | 0 | 0 | 0 |
| ABS polymer B | 6.0 | 0 | 0 | 6.0 | 6.0 | 0 | 0 | 0 | 0 |
| Thermal stabilizer | 0.1 | 0 | 0 | 0.1 | 0.1 | 0 | 0 | 0 | 0 |
| TPU | 0 | 5.0 | 5.0 | 5.0 | 10.0 | 5.0 | 10.0 | 5.0 | 10.0 |
| Antioxidant A | 0.2 | 0.2 | 0.2 | 0.2 | 0.2 | 0.2 | 0.2 | 0.2 | 0.2 |
| Antioxidant B | 0 | 0.1 | 0.1 | 0 | 0 | 0.1 | 0.1 | 0.1 | 0.1 |
| SAN | 0 | 24.0 | 7.0 | 0 | 0 | 24.0 | 24.0 | 7.0 | 7.0 |
| Graft polymer | 0 | 11.0 | 0 | 0 | 0 | 11.0 | 11.0 | 0 | 0 |
| UV Stabilizer | 0.5 | 0.5 | 0.5 | 0.5 | 0.5 | 0.5 | 0.5 | 0.5 | 0.5 |
| ABBS Copolymer | 0 | 0 | 21.0 | 0 | 0 | 0 | 0 | 21.0 | 21.0 |
| Polysiloxane | 0 | 0 | 0.25 | 0 | 0 | 0 | 0 | 0.25 | 0.25 |
| Impact modifer | 0 | 2.0 | 0 | 0 | 0 | 2.0 | 2.0 | 0 | 0 |
| Total | 100 | 100 | 100 | 100 | 100 | 100 | 100 | 100 | 100 |

TABLE II

| | Ex. 1 | Ex. 2 | Ex. 3 | Ex. 4 | Ex. 5 | Ex. 6 | Ex. 7 | Ex. 8 | Ex. 9 |
|---|---|---|---|---|---|---|---|---|---|
| Notched Izod at 23° C.-⅛ in. | 12.8 | 13.9 | 14.7 | 12.0 | 12.0 | 14.9 | 15.4 | 13.5 | 13.3 |
| thickness (ft · lbf/in) | | | | | | | | | |
| Notched Izod at −20° C.-⅛ in. | 11.0 | 4.4 | 13.6 | 9.9 | 9.7 | 4.6 | 5.3 | 11.1 | 11.3 |
| thickness (ft · lbf/in) | | | | | | | | | |
| Notched Izod at −30° C. ⅛ in. | 10.9 | 4.0 | 12.5 | 10.0 | 9.3 | 3.7 | 4.5 | 10.9 | 11.2 |
| thickness (ft · lbf/in) | | | | | | | | | |
| High Speed Puncture @23° C. | 40.7 | 35.8 | 42.7 | 39.0 | 38.2 | 35.7 | 34.5 | 35.1 | 32.3 |
| total energy (ft · lbf) | | | | | | | | | |
| High Speed Puncture @−20° C. | 38.6 | 33.5 | 37.3 | 41.3 | 40.8 | 34.4 | 34.4 | 38.0 | 39.9 |
| total energy (ft · lbf) | | | | | | | | | |
| High Speed Puncture @−30° C.- | 41.9 | 34.6 | 38.6 | 42.6 | 39.2 | 28.0 | 32.1 | 36.8 | 36.1 |
| total energy (ft · lbf) | | | | | | | | | |
| Specular Gloss at 20° C. | 76.2 | 5.8 | 2.8 | 89.7 | 88.7 | 15.6 | 8.5 | 5.3 | 3.9 |
| Specular Gloss at 60° C. | 98.4 | 37.9 | 18.5 | 101.0 | 101.0 | 57.4 | 49.0 | 36.5 | 28.0 |
| Specular Gloss at 85° C. | 98.3 | 81.9 | 62.6 | 98.3 | 98.8 | 88.1 | 85.6 | 82.2 | 74.2 |
| HDT648 (.455ST) Deflection | 124.2 | 117.7 | 125.9 | 118.5 | 115.6 | 108.7 | 102.8 | 117.6 | 114.4 |
| Temperature (° C.) | | | | | | | | | |
| HDT648 (1.82ST) Deflection | 101.6 | 99.1 | 107.2 | 94.0 | 90.0 | 85.6 | 78.2 | 91.6 | 82.6 |
| Temperature (° C.) | | | | | | | | | |
| VICAT (50NLD) softening | 125.6 | 119.5 | 131.2 | 114.4 | 106.9 | 108.8 | 101.7 | 116.1 | 108.8 |
| temperature (° C.) | | | | | | | | | |

TABLE III

| | Ex. 1 | Ex. 2 | Ex. 3 | Ex. 4 | Ex. 5 | Ex. 6 | Ex. 7 | Ex. 8 | Ex. 9 |
|---|---|---|---|---|---|---|---|---|---|
| Tensile strength at yield | 53.38 | | | 52.94 | 49.46 | 49.7 | 45.06 | 48.28 | 45 |
| (MPa) | | | | | | | | | |
| Tensile strength at break | 48.46 | | | 48.92 | 47.16 | 44.02 | 40.62 | 48.7 | 42.96 |
| (MPa) | | | | | | | | | |
| Ultimate tensile strength | 53.38 | | | 53.04 | 49.6 | 49.7 | 45.06 | 49 | 45.22 |
| (MPa) | | | | | | | | | |
| Elongation at yield (%) | 5 | | | 4.96 | 5.1 | 4.72 | 4.94 | 5.1 | 5.22 |
| Elongation at break (%) | 109.72 | | | 104.56 | 123 | 109.68 | 120.98 | 122.76 | 116.16 |
| Tensile modulus (MPa) | 2131.2 | | | 2048 | 1923.8 | 2051.6 | 1840 | 1815.2 | 1704.4 |
| Width (mm) | 12.578 | | | 12.59 | 12.588 | 12.575 | 12.582 | 12.57 | 12.573 |
| Thickness (mm) | 3.168 | | | 3.17 | 3.165 | 3.16 | 3.17 | 3.154 | 3.16 |
| Flexural modulus (MPa) | 2193.625 | | | 2149.55 | 1986.225 | 2063.05 | 1923.16 | 1907.98 | 1768.475 |
| Flexural stress at 5% | 89.425 | | | 87.725 | 81.4 | 83.325 | 74.56 | 79.2 | 71.7 |
| deflection (MPa) | | | | | | | | | |
| Strain at maximum stress | 5.825 | | | 5.775 | 5.9 | 5.875 | 5.84 | 6 | 6.075 |
| (%) | | | | | | | | | |
| Maximum flexural stress | 91.125 | | | 89.35 | 83.35 | 84.625 | 75.76 | 81.22 | 73.625 |
| (MPa) | | | | | | | | | |

The foregoing examples of the present invention are offered for the purpose of illustration and not limitation. It will be apparent to those ski/led in the art that the embodiments described herein may be modified or revised in various ways without departing from the spirit and scope of the invention. The scope of the invention is to be measured by the appended claims.

What is claimed is:

1. A method for improving damping performance and viscoelastic response in a vehicle interior part, the method comprising including a thermoplastic blend in the part, wherein the thermoplastic blend comprises about 50 to about 70 percent by weight of a thermoplastic aromatic polycarbonate and about 5 to about 10 percent by weight of a thermoplastic polyurethane, wherein the percents are based on the combined weights of the thermoplastic aromatic polycarbonate and thermoplastic polyurethane.

2. The method according to claim 1, wherein the thermoplastic blend comprises about 50 by weight of a thermoplastic aromatic polycarbonate.

3. The method according to claim 1, wherein the thermoplastic blend comprises about 5 percent by weight of a thermoplastic polyurethane.

4. The method according to claim 1, wherein the thermoplastic blend comprises about 10 percent by weight of a thermoplastic polyurethane.

5. The method according to claim 1, wherein the vehicle is selected from the group consisting of automobile, truck, bus, train and airplane.

6. A method for improving damping performance and viscoelastic response in a vehicle interior part, the method comprising including a thermoplastic blend in the part, wherein the thermoplastic blend comprises about 50 to about 70 percent by weight of a thermoplastic aromatic polycarbonate and about 5 to about 10 percent by weight of a thermoplastic polyester-polyol-based polyurethane, wherein the percents are based on the combined weights of the thermoplastic aromatic polycarbonate and thermoplastic polyurethane.

7. The method according to claim 6, wherein the thermoplastic blend comprises about 50 by weight of a thermoplastic aromatic polycarbonate.

8. The method according to claim 6, wherein the thermoplastic blend comprises about 5 percent by weight of a thermoplastic polyester-polyol-based polyurethane.

9. The method according to claim 6, wherein the thermoplastic blend comprises about 10 percent by weight of a thermoplastic polyester-polyol-based polyurethane.

10. The method according to claim 6, wherein the vehicle is selected from the group consisting of automobile, truck, bus, train and airplane.
